(19) United States
(12) Patent Application Publication
(10) Pub. No.: US 2020/0102186 A1
(43) Pub. Date: Apr. 2, 2020

(54) ELEVATOR SYSTEM

(71) Applicant: Otis Elevator Company, Farmington, CT (US)

(72) Inventor: Derk Pahlke, Berlin (DE)

(21) Appl. No.: 16/582,879

(22) Filed: Sep. 25, 2019

(30) Foreign Application Priority Data
Sep. 27, 2018 (EP) 18197162.3

(51) Int. Cl. B66B 5/00; B66B 1/28

(52) U.S. Cl. CPC B66B 5/0012; B66B 1/28

(57) ABSTRACT

An elevator system (2) comprises at least one elevator car (10) configured for traveling along a hoistway (4) between a plurality of landings (8); a plurality of passenger sensors (20a-20h) provided at at least one of the landings (8) and at least one evaluation unit (24). Each passenger sensor (20a-20h) is configured for detecting the presence of at least one person within a detection zone (22a-22h) associated with the respective passenger sensor (20a-20h) and for providing a corresponding detection signal indicating whether or not at least one person is present within the detection zone (22a-22h) associated with the respective passenger sensor (20a-20h). The at least one evaluation unit (24) is configured for determining the number of passengers (26) present at the respective landing (8) from a combination of the detection signals provided by the plurality of passenger sensors (20a-20h).

### FOREIGN PRIORITY

This application claims priority to European Patent Application No. 18197162.3, filed Sep. 27, 2018, and all the benefits accruing therefrom under 35 U.S.C. § 119, the contents of which in its entirety are herein incorporated by reference.

### BACKGROUND

The invention relates to an elevator system, in particular to an elevator system comprising a plurality of passenger sensors.

An elevator system comprises at least one elevator car moving between a plurality of landings and control panels located at the landings (landing control panels) allowing passengers to enter a request for transportation.

In case of heavy traffic, i.e. in a situation in which a plurality of passengers simultaneously desire to use the elevator system, it would be beneficial if the elevator system would send at least one elevator car to a crowded floor even before a request for transportation has been entered.

### SUMMARY

According to an exemplary embodiment of the invention, an elevator system comprises at least one elevator car configured for traveling along a hoistway between a plurality of landings, a plurality of passenger sensors provided at at least one of the landings, and at least one evaluation unit. Each passenger sensor is configured for detecting the presence of at least one person within a detection zone associated with the respective passenger sensor and for providing a corresponding detection signal indicating whether or not at least one passenger is present within the detection zone associated with the respective passenger sensor. The at least one evaluation unit is configured for determining a number of passengers being present at the respective landing from a combination of the detection signals provided by the plurality of passenger sensors.

Exemplary embodiments of the invention also include a method of controlling an elevator system according to an exemplary embodiment of the invention, wherein the method includes determining the number of passengers being present at at least one of the landings, and controlling the movement of the at least one elevator car based on the determined number of passengers.

The detection signals provided by the plurality of passenger sensors allow the evaluation unit to determine the number of passengers being present at the respective landing. This allows a control of the elevator system (elevator control) to control the movement of the at least one elevator car based on the determined number of passengers for enhancing the efficiency of the elevator system and for minimizing the average waiting time of the passengers waiting for an elevator car to arrive at their respective landing.

As the passenger sensors need to be configured for providing only binary detection signals, i.e. signals indicating whether or not at least one passenger is present within the detection zone associated with the respective passenger sensor, the passenger sensors may be provided at low costs. Thus, despite providing a plurality of passenger sensors, the additional costs for providing the passenger sensors are limited.

As a result, the efficiency of the elevator system may be enhanced without considerably increasing the total costs of the elevator system.

A number of optional features are set out in the following. These features may be realized in particular embodiments, alone or in combination with any of the other features, unless specified otherwise.

The passenger sensors may be configured for providing detection signals comprising not more than 8 bits (1 Byte) of information. The passenger sensors in particular may be configured for providing detection signals comprising only 1, 2, 3, 4, 5, 6, 7, or 8 bits of information.

The passenger sensors may be configured for providing detection signals comprising only one bit of information indicating whether or not at least one person is present in the detection zone associated with the respective passenger sensor.

Alternatively, the passenger sensors may be configured for providing detection signals comprising two or more bits of information indicating whether no passenger, one passenger, a small number of passengers, or a large number of passengers is present within the detection zone associated with the respective passenger sensor.

Passenger sensors configured for providing detection signals comprising only a small number of bits may be provided at low costs.

The passenger sensors may be at least one of temperature sensors, in particular pyroelectric sensors, detecting heat generated by the passengers, acoustic sensors, radar sensors, in particular radar sensors using mm waves, and optic sensors configured for detecting the presence of a person (passenger) within a predefined detection zone. The passenger sensors may be configured for providing a positive signal in case the presence of at least one passenger within the associated detection zone is detected. The passenger sensors may be configured for providing a negative signal or no signal at all in case no passenger is detected within the associated detection zone.

The passenger sensors may be configured for transmitting the detection signals to the evaluation unit via a wireless data transmission. The wireless data transmission may include Bluetooth® Low Energy (BLE), WI-Fi HaLow (801.11ah), a wireless Mbus or a similar technology. The wireless data transmission in particular may include the BLE beacon mode avoiding the overhead of a handshake connection mode. Employing a wireless data transmission avoids the costs and the efforts for running electrical cables between the passenger sensors and the evaluation unit.

A receiving device configured for receiving the wireless data transmission signal emitted by the passenger sensors may be connected or integrated with an evaluation unit. The receiving device and/or the evaluation unit may be integrated in a group (ring) communication of the elevator control, such as a RS422 group ring.

An evaluation unit may be provided at every floor or at selected floors of the elevator system with each evaluation unit being configured for receiving, e.g. via a receiving device, and processing detection signals provided by the passenger sensors arranged at the same floor as the evaluation unit.

In order to avoid the need of connecting the passenger sensors by electrical wires to a central power supply, the passenger sensors may be operable without being connected to an external electrical power supply.

Each of the passenger sensors in particular may comprise a local power supply such as at least one battery and/or solar cell configured for providing the electrical energy needed for operating the respective passenger sensor.

The evaluation unit may be configured for supplying a signal indicating that there is a need of transporting an increased number of passengers from at least one of the landings.

An elevator system according to an exemplary embodiment of the invention may comprise an elevator control which is configured for controlling the movement of the elevator car, and the evaluation unit may be configured for supplying to the elevator control a signal indicating the number of passengers being present at a respective landing, or a signal indicating that the number of passengers at a respective landing exceeds a predefined limit.

Such a configuration allows the elevator control to adjust the operation of the elevator system, in particular the dispatching of the elevator cars, according to the detected number of passengers. It in particular allows the elevator control to switch the operation of the elevator system to a heavy traffic mode, when the number of detected passengers exceeds the predefined limit.

The elevator control in particular may be configured for moving an elevator car or a plurality of elevator cars to a landing at which the number of detected passengers exceeds the predefined limit.

The elevator control may be a central elevator control including a single elevator controller.

Alternatively, the elevator control may be a decentralized elevator control comprising a plurality of interacting elevator controllers. The plurality of elevator controllers may communicate with each other via an elevator control information bus, such as a CAN bus. This may include wireless data transmission.

The at least one evaluation unit may be connected to the elevator control information bus for communicating with the plurality of elevator controllers. The plurality of elevator controllers may be connected with each other forming a linear configuration, a ring configuration, a star configuration or a mesh configuration.

In the case of a decentralized elevator control, a single elevator controller may be assigned to every landing, to every elevator car and/or to every hoistway of the elevator system, respectively. In another configuration, a single elevator controller may be assigned to a group of landings, a group of elevator cars and/or to a group of hoistways, respectively.

The evaluation unit may be configured for determining the number of passengers approaching at least one landing door at the respective landing. The number of passengers approaching the at least one landing door may be determined by evaluating detection signals provided by passenger sensors arranged in different distances from the landing doors.

As a result, the operation of the elevator system may be adjusted even better to the number of passengers, as persons passing the landings in the vicinity of the landing doors without actually approaching the landing doors may be ignored. In consequence, the risk of a disadvantageous operation of the elevator system due to persons erroneously identified as passengers of the elevator system may be reduced.

The detection zones of the passenger sensors may be configured so that they do not overlap. In such a configuration, every passenger is detected by only one of the passenger sensors, and every detected passenger may be unambiguously assigned to one and only one of the detection zones. Such an unambiguous assignment of the passengers facilitates identifying the moving direction of the passengers and determining the number of passengers actually approaching the landing doors.

In an alternative embodiment, the detection zones of the passenger sensors overlap so that a single passenger may be detected simultaneously by at least two passenger sensors. Overlapping detection zones reduce the risk that a passenger is not detected as he is located in a “dead area”, i.e. an area located between two adjacent detection zones.

### DRAWING DESCRIPTION

In the following, exemplary embodiments of the invention are described in more detail with respect to the enclosed figures:

FIG. 1 schematically depicts an elevator system according to an exemplary embodiment of the invention.

FIG. 2 shows a schematic top view of a landing of an elevator system according to an exemplary embodiment of the invention.

### DETAILED DESCRIPTION

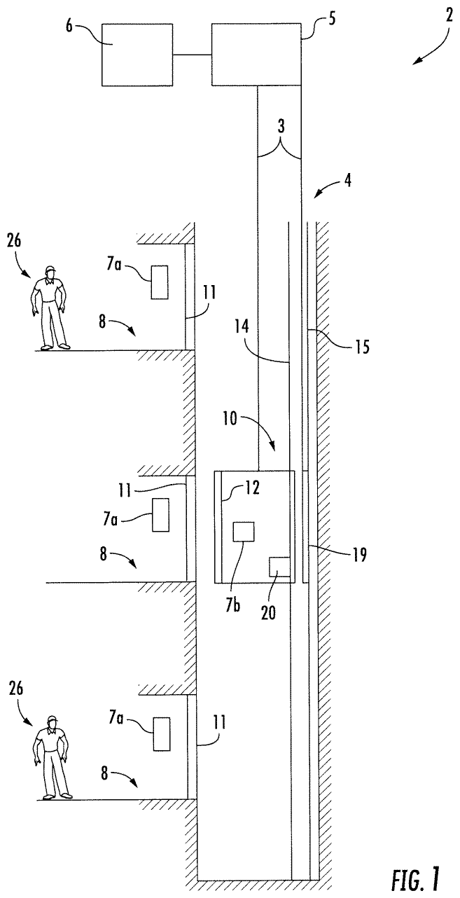

FIG. 1 schematically depicts an elevator system 2 according to an exemplary embodiment of the invention.

The elevator system 2 includes an elevator car 10 movably arranged within a hoistway 4 extending between a plurality of landings 8. The elevator car 10 in particular is movable along a plurality of car guide members 14, such as guide rails, extending along the vertical direction of the hoistway 4. Only one of said car guide members 14 is visible in FIG. 1.

Although only one elevator car 10 is depicted in FIG. 1, the skilled person will understand that exemplary embodiments of the invention may include elevator systems 2 having a plurality of elevator cars 10 moving in one or more hoistways 4.

The elevator car 10 is movably suspended by means of a tension member 3. The tension member 3, for example a rope or belt, is connected to a drive unit 5, which is configured for driving the tension member 3 in order to move the elevator car 10 along the height of the hoistway 4 between the plurality of landings 8, which are located on different floors.

Each landing 8 is provided with a landing door 11, and the elevator car 10 is provided with a corresponding elevator car door 12 for allowing passengers 26 to transfer between a landing 8 and the interior of the elevator car 10 when the elevator car 10 is positioned at the respective landing 8.

The exemplary embodiment of the elevator system 2 shown in FIG. 1 employs a 1:1 roping for suspending the elevator car 10. The skilled person, however, easily understands that the type of the roping is not essential for the invention and that different kinds of roping, e.g. a 2:1 roping, may be used as well. The elevator system 2 may have a machine room or may be a machine room-less elevator system. The elevator system 2 may use a tension member 3, as it is shown in FIG. 1, or it may be an elevator system without a tension member 3. The drive 5 may be any form of drive used in the art, e.g. a traction drive, a hydraulic drive or a linear drive.

The elevator system 2 shown in FIG. 1 further includes a counterweight 19 attached to the tension member 3 and moving concurrently and in opposite direction with respect to the elevator car 10 along at least one counterweight guide member 15. The skilled person will understand that the invention may be applied also to elevator systems 2 which do not comprise a counterweight 19.

The tension member 3 may be a rope, e.g. a steel wire rope, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3.

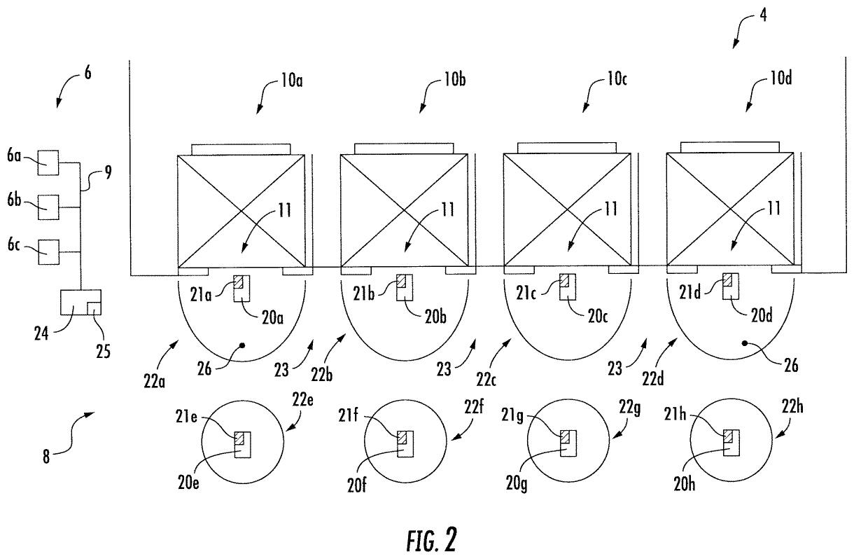

The drive unit 5 is controlled by an elevator control 6 for moving the elevator car 10 along the hoistway 4 between the different landings 8. In FIG. 1, the elevator control 6 is depicted only schematically. The elevator control 6 in particular may include a plurality of controllers 6a, 6b, 6c (see FIG. 2), with each controller 6a, 6b, 6c being arranged at one of the landings 8 and/or at one of the hoistways 4 in case the elevator system 2 comprises a plurality of hoistways 4.

Input to the elevator control 6 may be provided via landing control panels 7a, which are provided on each landing 8 in the vicinity the landing doors 11, and/or via an elevator car control panel 7b provided inside the elevator car 10.

The elevator control 6 in particular may be configured for destination dispatching. In case of destination dispatching, passengers 26 input their respective desired destination landings via the landing control panels 7a before entering an elevator car 10. The elevator control 6 then assigns each of the passengers 26 to a dedicated elevator car 10 in order to optimize the transport capacity and the transport speed of the elevator system 2. In particular, passengers 26 with the same destination landing may be assigned to the same elevator car 10 in order to reduce the number of stops of the elevator cars 10.

The landing control panels 7a and the elevator car control panel 7b may be connected to the elevator control 6 by means of electric wires, which are not shown in FIG. 1, in particular by an electric bus, such as a field bus/CAN-bus, or by means of wireless data connections.

FIG. 2 depicts a schematic top view of landing 8 of an elevator system 2 according to an embodiment of the invention.

The elevator system 2 comprises a plurality of elevator cars 10a-10d traveling parallel to each other within a common hoistway 4. In alternative embodiments, which are not depicted in the figures, the elevator cars 10a-10d may travel in a plurality of hoistways 4. One or more elevator cars 10a-10d may travel in each of the plurality of hoistways 4.

Although four elevator cars 10a-10d are shown in FIG. 2, the skilled person understands that this is only an exemplary embodiment and that other exemplary embodiments of the invention may comprise fewer or more than four elevator cars 10a-10d.

A plurality of passenger sensors 20a-20h are provided at the landing 8. Each passenger sensor 20a-20h is configured for detecting the presence of at least one passenger 26 within a detection zone 22a-22h associated with the respective passenger sensor 20a-20h. Each of the passenger sensors 20a-20h in particular is configured for providing a detection signal indicating whether or not at least one passenger 26 is present within the detection zone 22a-22h associated with the respective passenger sensor 20a-20h.

Each of the passenger sensors 20a-20h may comprise a local power supply 21a-21h, such as a battery or a solar cell, which is configured for providing the electrical energy needed for operating the respective passenger sensor 20a-20h. Passenger sensors 20a-20h comprising a local power supply 21a-21h do not need to be connected with a central power supply (not shown). In consequence, no additional wiring is necessary for supplying the passenger sensors 20a-20h with electrical energy. This facilitates the installation of the passenger sensors 20a-20h.

In one embodiment, as it is depicted in FIG. 2, the detection zones 22a-22h of the passenger sensor 20a-20h may be configured so that they do not overlap forming gaps 23 between adjacent detection zones 22a-22h. If the gaps 23 between adjacent detection zones 22a-22h are large enough, every passenger 26 is detected by only one of the passenger sensors 20a-20h. Thus, every detected passenger 26 may be unambiguously assigned to one and only one of the detection zones 22a-22h. There, however, is some risk that some passengers 26 are not detected at all because they are located in one of the gaps 23. In order to reduce the risk that a passenger 26 is detected either simultaneously by two or more passenger sensors 20a-20h, or by no passenger sensor 20a-20h at all, the detection zones 22a-22h may be designed so that the horizontal extensions of the gaps 23 basically correspond to the average horizontal extension of a standing passenger 26.

In an alternative embodiment, which is not depicted in the figures, the detection zones 22a-22h of the passenger sensors 20a-20h overlap. As a result, passengers 26 located in a region in which at least two detection zones 22a-22h overlap are detected simultaneously by said at least two passenger sensors 20a-20h. In consequence, the detection signals provided by the passenger sensors 20a-20h do not exactly correspond with the number of passengers 26 within the detection zones 22a-22h.

An elevator system 2 according to an exemplary embodiment of the invention further comprises at least one evaluation unit 24.

The at least one evaluation unit 24 is configured for determining the number of passengers 26 present at the respective landing 8 from detection signals provided by the plurality of passenger sensors 20a-20h and received by the evaluation unit 24.

For example, each of the passenger sensors 20a-20h may be configured for sending a signal indicating whether a passenger 26 is present within the detection zone 22a-22h of the respective passenger sensor 20a-20h (positive signal) or not (negative signal or no signal). In such a configuration, the evaluation unit 24 only needs to count the number of positive signals received in order to determine the (approximate) number of passengers 26 at the respective landing 8.

In case of overlapping detection zones 22a-22h, or if more than one passenger 26 is present within a single detection zone 22a-22h, the number of passengers 26 present at the respective landing 8 may be determined only approximately. Determining an approximate number of the passengers 26 at the respective landing, however, is sufficient for the intended purpose of estimating the current traffic load on the respective landing 8 of the elevator system 2 in order to dispatch the elevator cars 8 accordingly.

The passenger sensors 20a-20h and the evaluation unit 24 may be configured for transmitting the detection signals via wireless data connections, such as WLAN or Bluetooth®, or via electrical wires, which are not shown in the figures.

The wireless data transmission in particular may include the BLE beacon mode which avoids the overhead of a handshake connection mode. Employing a wireless data transmission avoids the costs and the efforts for running electrical cables between the passenger sensors 20a-20h and the evaluation unit 24.

A receiving device 25 configured for receiving the wireless data transmission signal emitted by the passenger sensors 20a-20h may be connected or integrated with each evaluation unit 24. The receiving device 25 may be integrated in a group (ring) communication of the elevator control, e.g. a RS422 group ring.

The passenger sensors 20a-20h may be configured for transmitting the detection signals to the evaluation unit 24 via a star configuration or via a mesh configuration in which at least some of the passenger sensors 20a-20h act as relays forwarding the detection signals of adjacent passenger sensors 20a-20h.

The evaluation unit 24 may deliver the evaluation result, i.e. the number of passengers 26 detected at the respective landing 8, to the elevator control 6. In an alternative configuration, the evaluation unit 24 may be configured for comparing the determined number of passengers 26 at the respective landing 8 with a predefined limit and transmit a signal indicating heavy traffic in case the determined number exceeds the predefined limit.

The elevator control 6 is configured to react to a signal received from the evaluation unit 24 indicating heavy traffic by switching to a heavy traffic mode of operation. The heavy traffic mode in particular may include sending at least one additional elevator car 10 to the landing 8 at which heavy traffic has been detected in order to reduce the waiting times of the passengers 26 at the respective landing 8.

The signal provided by the evaluation unit 24 is handled as an input to the elevator control 6 indicating heavy traffic. The evaluation of the detection signals is done by the evaluation unit 24. Thus, there is no need to modify the software or hardware of the elevator control 6 itself. Instead, any elevator control 6 which is capable of receiving a signal indicating heavy traffic and switching to a heavy traffic mode of operation upon receiving such a signal may be employed. In consequence, passenger sensors 20a-20h and evaluation units 24 according to exemplary embodiments of the invention may be combined easily with existing elevator controls 6, e.g. in the course of modernizing existing elevator systems 2.

In further embodiments, the evaluation unit 24 may comprise advanced computing and/or self-learning capabilities which allow activating a heavy traffic mode of operation based on the signals received from the passenger sensors 20a-20h. The advanced computing and/or self-learning capabilities may include using further information, such as the time of the day and/or additional information received from the elevator control 6.

As mentioned before, the elevator control 6 may comprise a plurality of controllers 6a-6c connected with each other by an elevator control information bus 9. The evaluation unit 24 may be connected to the elevator control information bus 9 as well in order to transmit the evaluation result to controllers 6a-6c constituting the elevator control 6.

The plurality of elevator controllers 6a-6c may be connected to each other in a linear configuration, in a ring configuration, in a star configuration or in a mesh configuration.

Optionally, the evaluation unit 24 may be configured for determining the number of passengers 26 approaching at least one landing door 11 located at the respective landing 8. The number of passengers 26 approaching the at least one landing door 11 may be determined by evaluating detection signals provided by passenger sensors 20a-20h arranged in different distances from the landing doors 11.

As a result, the operation of the elevator system 2 may be adjusted even better to the current number of passengers 26, as persons passing the landing 8 in the vicinity of the landing doors 11 without actually approaching the landing doors 11 may be ignored. In consequence, the risk of a disadvantageous operation of the elevator system 2 due to persons erroneously identified as passengers 26 of the elevator system 2 may be reduced.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 drive unit
6 elevator control
6a-6c controller
7a landing control panel
7b elevator car control panel
8 landing
9 elevator control information bus
10 elevator car
11 landing door
12 elevator car door
14 car guide member
15 counterweight guide member
19 counterweight
20a-20h passenger sensor
21a-21h local power supply
22a-22h detection zone
23 gap
24 evaluation unit
25 receiving device
26 passenger

What is claimed is:

1. Elevator system (2) comprising:
at least one elevator car (10) configured for traveling along a hoistway (4) between a plurality of landings (8);
a plurality of passenger sensors (20a-20h) provided at at least one of the landings (8), each passenger sensor (20a-20h) being configured for detecting the presence of at least one person within a detection zone (22a-22h) associated with the respective passenger sensor (20a-20h) and for providing a corresponding detection signal indicating whether or not at least one person is present within the detection zone (22a-22h) associated with the respective passenger sensor (20a-20h); and
at least one evaluation unit (24) configured for determining a number of passengers (26) present at the respective landing (8) from the a combination of the detection signals provided by the plurality of passenger sensors (20a-20h).

2. Elevator system (2) according to claim 1, wherein the passenger sensors (20a-20h) are at least one of pyroelectric sensors, acoustic sensors, millimeter wave radar sensors and optic sensors.

3. Elevator system (2) according to claim 1, wherein the passenger sensors (20a-20h) are configured for transmitting the detection signals to the evaluation unit (24) via wireless data transmission.

4. Elevator system (2) according to claim 1, wherein the passenger sensors (20a-20h) are configured for providing detection signals comprising not more than eight bits of information, wherein the passenger sensors (20a-20h) in particular are configured for providing detection signals comprising only one bit or two bits of information.

5. Elevator system (2) according to claim 1, wherein the passenger sensors (20a-20h) are operable without being connected to an external electrical power supply.

6. Elevator system (2) according to claim 5, wherein at least one of the passenger sensors (20a-20h) comprises an autonomous power supply (21a-21h), in particular including at least one battery and/or at least one solar cell, for providing electrical energy used for operating the respective passenger sensor (20a-20h).

7. Elevator system (2) according to claim 1, wherein the evaluation unit (24) is configured for supplying a signal indicating that there is a need of transporting a group of passengers (26) from at least one of the landings (8).

8. Elevator system (2) according to claim 1, comprising an elevator control (6) configured for controlling the movement of the elevator car (10), wherein the evaluation unit (24) is configured for supplying a signal to the elevator control (6), the signal indicating the number of passengers (26) being present at the respective landing (8) or that the number of passengers (26) at a respective landing (8) exceeds a predefined limit.

9. Elevator system (2) according to claim 8, wherein the elevator control (6) is configured for causing at least one elevator car (10), in particular a plurality of elevator cars (10), to be moved to one of the landings (8) when the determined number of passengers (26) at the respective landing (8) exceeds a predefined limit.

10. Elevator system (2) according to claim 1, wherein the evaluation unit (24) is configured for determining movement of passengers (26) at the respective landing (8) from the detection signals provided by the plurality of passenger sensors (20a-20h).

11. Elevator system (2) according to claim 10, wherein the evaluation unit (24) is configured for determining the number of passengers (26) approaching at least one landing door (11) located at the respective landing (8).

12. Elevator system (2) according to claim 1, wherein each of the passenger sensors (20a-20h) has a detection zone (22a-22h), and wherein the detection zones of at least two of the passenger sensors (20a-20h) overlap with each other.

13. Elevator system (2) according to claim 1, wherein each of the passenger sensors (20a-20h) has a detection zone (22a-22h), and wherein the detection zones of the passenger sensors (20a-20h) do not overlap with each other.

14. Method of controlling an elevator system (2) according to claim 1, wherein the method includes
determining a number of passengers (26) being present at at least one of the landings (8); and
controlling the movement of the at least one elevator car (10) based on the determined number of passengers (26).

15. Method according to claim 14, wherein the method includes moving at least one elevator car (10) to a landing (8) when the determined number of passengers (26) at the respective landing (8) exceeds a predefined limit.
